(19) United States
(12) Patent Application Publication
(10) Pub. No.: US 2017/0156375 A1
(43) Pub. Date: Jun. 8, 2017

(54) METHOD FOR THE PREPARATION OF AN ACID DAIRY DRINK AND SAID ACID DAIRY DRINK

(71) Applicant: FrieslandCampina Nederland B.V., Amersfoort (NL)

(72) Inventors: William KLOEK, Wageningen (NL); Matthias Dominik EISNER, Wageningen (NL); Johanna Maria Jozefa Georgina LUYTEN, Wageningen (NL); Thom HUPPERTZ, Wageningen (NL)

(73) Assignee: FrieslandCampina Nederland B.V., Amersfoort, (NL)

(21) Appl. No.: 15/313,299

(22) PCT Filed: May 22, 2015
(86) PCT No.: PCT/NL2015/050369

§ 371 Date: Nov. 22, 2016

(30) Foreign Application Priority Data
May 23, 2014 (EP) 14169683.1

(51) Int. Cl. A23L 2/68; A23C 9/13; A23L 2/66; A23C 9/12

(52) U.S. Cl. CPC A23L 2/68; A23C 9/1216; A23C 9/1307; A23L 2/66; A23V 2002/00

(57) ABSTRACT

The present invention relates to a method for the preparation of an acid dairy drink comprising the steps of: a) providing an aqueous dairy protein composition comprising: —at least 1% by weight casein and/or caseinate; —at least 60% by weight water; —a pH in the range of 5.5 to 8; b) adding a deamidating enzyme to the aqueous dairy protein composition in order to deamidate the casein and/or caseinate to a deamidation ratio of the deamidated casein and/or caseinate of 50% or more is achieved; and c) adjusting the pH of the composition between 4.8 and 5.4. Preferably, the aqueous dairy protein composition is incubated for such a period of time that the iso-electrical point of the deamidated casein or caseinate formed is at least 0.5 lower than native casein or non-deamidated caseinate, respectively. The so obtained drinks are also claimed.

### TECHNICAL FIELD OF THE INVENTION

The present invention relates to a method for the preparation of an acid dairy drink comprising casein and/or caseinate. The present invention further relates to an acid dairy drink obtainable by said method and to an acid dairy drink as such.

### BACKGROUND OF THE INVENTION

Acid dairy drinks, such as yoghurt drinks, are popular consumer drinks. One of the advantages of such dairy drinks is that they have a pleasant taste and that they are associated with healthy foods.

Particularly due to the relatively high amount of proteins, such as casein or caseinates, these drinks may also be used to administer proteins to people in need thereof. Particularly, the elderly, persons suffering from decubitus ulcers or people recovering from surgery have a special need for a relatively high protein intake.

Ideally, such an increased need of proteins is provided by means of an acid dairy drink. Compared to solid foods, dairy drinks, especially acid dairy drinks, are easy to swallow, more appreciated over neutral dairy drinks, and are most often ready to use and are relatively easy to package and distribute.

However, the increased amount of dairy proteins, in particularly the amount of casein and/or caseinate, in acid dairy drinks generally leads to a significant increase of the viscosity of the drink which makes the beverage undesirable for consumption. Especially in the pH range of 4.5 to 5.4 casein will coagulate relatively quickly and form a gel. In addition, it may lead to physico-chemical instability issues such as flocculation, coagulation and phase separation (sedimentation).

Acid dairy drinks which are known in the art and which comprise casein and/or caseinate and have a pH in the range of 3.8 to 5.4 are made from dairy gels which have been broken by means of stirring. However, due to the breakage of such gels, syneresis occurs which will lead to phase separation, stability issues and a reduced shelf life.

In order to avoid gelation and instability issues it has been suggested in the art to only use relatively low amounts of casein or caseinate or to use a pH which is sufficiently far removed from the iso-electric point of the casein, casein micelles and caseinate.

However, working outside this pH range also leads to problems. On the one hand at relatively high pH, such as a pH above 6, a fresh, fruity/acid taste of drinks is less well noticed than in acid drinks.

On the other hand, a pH below 4.5 may be considered by consumers as too sour. In this regard it is also noted that especially in high protein compositions the buffer capacity of the proteins increases significantly. In order to lower the pH below 4.5 a lot of acid is required, which results in a higher acidity and a strong sour taste of such products. This is often compensated by the addition of sugar, however sugars as additives are increasingly negatively perceived.

Hence a need exists for an acid dairy drink with a relatively high amount of dairy proteins, in particular casein and/or caseinate, with an acceptable viscosity, a pleasant taste and a good stability and shelf life.

### SUMMARY OF THE INVENTION

A first aspect of the present invention relates to a method for the preparation of an acid dairy drink comprising at least 1% by weight casein and/or caseinate, wherein the method comprises the steps of:
a) providing an aqueous dairy protein composition comprising:
   at least 1% by weight casein and/or caseinate;
   at least 60% by weight water;
   a pH in the range of 5.5 to 8;
b) adding a deamidating enzyme to the aqueous dairy protein composition and letting the enzyme deamidate the casein and/or caseinate present in said composition, such that a deamidation ratio of the deamidated casein and/or caseinate of 50% or more is achieved; and
c) adjusting the pH of the composition to a pH between 4.8 and 5.4, such that an acid dairy drink is obtained.

With the method of the present invention an acid dairy drink may be prepared which has relatively high protein content compared to other drinks, in particularly a relatively high casein and/or caseinate content, whilst having a pH which is perceived by many consumers as very pleasant.

Moreover, the acid dairy drink prepared according to the method of the present invention does not exhibit serum formation and has an excellent stability and shelf life.

A second aspect of the present invention relates to an acid dairy drink obtainable by the method according to the present invention.

A third aspect of the present invention relates to an acid dairy drink comprising:
at least 60% by weight water;
a pH between 4.8 and 5.4;
at least 1% by weight deamidated casein and/or
   deamidated caseinate, wherein the deamidated casein and/or caseinate has an iso-electrical point which is at least 0.5 below the iso-electrical point (IEP) of native casein or non-deamidated caseinate, respectively.

The drink according to the present invention provides for the first time, an acid dairy drink having a relatively high dairy protein content, in particularly a high casein and/or caseinate content, an acidity which is in general positively perceived by consumers and which has an excellent stability and shelf life.

### DEFINITIONS

The term “protein” as used herein has its conventional meaning and refers to a linear polypeptide comprising at least 10 amino acid residues.

The term “dairy protein” as used herein has its conventional meaning and refers to proteins, such as casein, caseinate and whey, present in milk from human or non-human mammals, such as bovines (e.g. cows), goats, sheep or camels.

The term “casein” as used herein has its conventional meaning and refers to the non-globular proteins found in milk and comprises the proteins α_{S1}-casein, α_{S2}-casein, β-casein and κ-casein. Within the context of the present application the term casein also encompasses micellar casein and caseins treated with non-deamidating enzymes (Walstra et al., Dairy Science and Technology, 2006).), Furthermore, within the context of the present invention the term casein also encompasses casein which has been subjected to a deamidation treatment, i.e. deamidated casein.

The term “caseinate” as used herein has its conventional meaning and refers to acid precipitated casein which has been neutralized again using alkaline agents like NaOH, KOH, Mg(OH)2 Ca(OH)2, NH4OH and comprises calcium caseinate, sodium caseinate, potassium caseinate, magnesium caseinate, ammonium caseinate or a mixture thereof (Walstra, 2006). Furthermore, within the context of the present invention the term caseinate also encompasses caseinate which has been subjected to a deamidation treatment, i.e. deamidated caseinate.

The terms “deamidated casein” and “deamidated caseinate” as used herein refer to casein or caseinate which has been subjected to a deamidation treatment.

The term “gel” as used herein has its conventional meaning and refers to an aqueous system, which does not exhibit flow when in a steady state.

The term “drink” and “beverage” are used interchangeably and have their conventional meaning and refer to a pourable liquid system having a viscosity of less than 75 mPa·s.

The term “acid dairy drink” as used herein refers to a drink comprising dairy proteins which has a pH below the natural pH of milk, in particular bovine milk.

The term “deamidation” as used herein has its conventional meaning and refers to a chemical reaction in which an amide functional group is removed from an organic compound, in particular the transformation of a glutamine residue in a protein to a glutamic acid residue.

The term “deamidating enzyme” as used herein has its conventional meaning and refers to an enzyme which catalyzes the reaction of deamidation.

The term “deamidation ratio” as used herein has its conventional meaning and refers to the degree wherein the glutamine residues in the dairy proteins contained in a composition were deamidated by a protein deamidating enzyme.

This “deamidation ratio” may be determined by methods known in the art, such as described in EP2474230 (par. 43), wherein the deamidation ratio is determined by determining the concentration ammonia in a dairy protein composition and dividing this amount by the concentration ammonia in said dairy protein composition wherein all the glutamine residues of all the dairy proteins contained in said composition have been deamidated by a protein deamidating enzyme.

The term “iso-electric point (IEP)” as used herein has its conventional meaning and refers to the pH at which a particular protein carries no net electrical charge. The IEP of deamidated casein or caseinate may be determined by methods well known in the art, such as electrophoresis (Giambra et al., 2010 in Small Ruminant Research). A particularly suitable way of determining the IEP is by means of the Pharmacia PhastSystem electrophoresis system (Pharmacia technical note no. 2, 1992).

The term “skimmed milk” as used herein has its conventional meaning and refers to milk, which has been defatted to a fat content below 0.3% by weight.

### DETAILED DESCRIPTION OF THE INVENTION

A first aspect of the present invention relates to a method for the preparation of an acid dairy drink comprising at least 1% by weight casein and/or caseinate, wherein the method comprises the steps of:
a) providing an aqueous dairy protein composition comprising:
   at least 1% by weight casein and/or caseinate;
   at least 60% by weight water;
   a pH in the range of 5.5 to 8;
b) adding a deamidating enzyme to the aqueous dairy protein composition and letting the enzyme deamidate the casein and/or caseinate present in said composition, such that a deamidation ratio of the deamidated casein and/or caseinate of 50% or more is achieved; and
c) adjusting the pH of the composition to a pH between 4.8 and 5.4, such that an acid dairy drink is obtained.
   With the method of the present invention an acid dairy drink may be prepared which has a relatively high protein content, in particular a relatively high casein and/or caseinate content, whilst having a pH which lies within the range which is most preferred by consumers for these kinds of drinks.

Moreover, the acid dairy drink prepared according to the method of the present invention essentially does not exhibit serum formation and has an excellent stability and shelf life.

Hence, with the method of the present invention, persons may be provided with extra protein via an attractive dairy drink. This is particularly advantageous for persons having an increased demand for proteins such as persons recovering from an operation or for the elderly which generally suffer from a reduced daily intake of nutrients, in particular proteins.

Due to the well-balanced amino-acid composition of casein, it is one of the preferred proteins to provide to person in need of extra protein. Hence, a relatively high amount of this protein in a dairy drink is very advantageous.

Without wishing to be bound by any theory, it is assumed that due to the increase of gamma-glutamic acid residues in the casein and caseinate subjected to the deamidation treatment a lowering of the iso-electric point of the casein and/or caseinate has occurred. Hence, it is possible to incorporate in the dairy drink within the pH-range of 4.8 to 5.4 more casein and/or caseinate without running the risk that said proteins form a gel.

In one embodiment of the present invention the aqueous composition of step a) comprises preferably 2 to 5% by weight casein. Such an amount of casein is particularly useful when making so called easy to drink convenience dairy drinks.

A particularly suitable starting material for these types of drinks is milk or skimmed milk. Milk or skimmed milk is preferred for reasons that they comprise a relatively high amount of casein and are readily available to the person skilled in the art. Said milk or skimmed milk has preferably been derived from bovine, such as cows.

As another source of casein or as an additional source of casein a micellar casein isolate obtained by microfiltration may be used. Furthermore, the casein used in the composition of the present invention may also come from a milk protein isolate or a milk protein concentrate.

In a preferred embodiment the aqueous dairy composition of step a) is a micellar casein isolate, a milk protein isolate, a milk protein concentrate or a mixture of any of these.

In another embodiment, which is more suitable for medical nutrition, a relatively high amount of caseinate is used. In such an embodiment, the aqueous dairy protein composition of step a) preferably comprises between 5 to 20% by weight caseinate

In view of the above, the acid dairy drinks prepared with the method according to the present invention thus comprises at least 1% by weight casein and/or caseinate. However, in view of the preferred amounts of casein and/or caseinate referred to above, the dairy drink may comprises considerably more protein. Hence, in a preferred embodiment, the acid dairy drink obtained with the method according to the present invention comprises at least 2% by weight and preferably at least 2.5% by weight casein and/or caseinate.

The water content of the aqueous dairy protein composition of step a) is preferably between 60 and 98% by weight. It is particularly preferred that the water content lies between 70 and 95% by weight.

The deamidating enzyme used in the method of the present invention is preferably a protein-glutaminase (PG).

In step b) of the method of the present invention the concentration of the deamidating enzymes, such as protein-glutaminase, is 0.01 to 100 units per gram of the aqueous dairy protein composition, preferably 0.01 to 10 units per gram of the aqueous dairy protein composition.

In order to allow the deamidating enzymes to deamidate a sufficient part of the glutamine residues in the casein and/or caseinate, the aqueous dairy protein composition is preferably incubated with the deamidating enzymes for at least one minute at 10 to 60° C.

In a particularly preferred embodiment of the present invention, in step b) the aqueous dairy protein composition is incubated for at least 2 hours at 40° to 60° C. with 0.01 to 10 units protein-transglutaminase per gram of the aqueous dairy protein composition.

Typically, in step b) the aqueous dairy protein composition is incubated for such a period of time that the iso-electrical point of the deamidated casein or caseinate formed is at least 0.5 lower than native casein or non-deamidated caseinate, respectively.

Hence, after deamidation the iso-electrical point of the deamidated α_{S1}-casein will typically be 4 or less; for deamidated α_{S2}-casein it will be 4.5 or less; for deamidated β-casein it will be 4.3 or less; and for deamidated κ-casein it will be 5.1 or less.

The iso-electrical point of the deamidated casein or caseinate may be determined by methods commonly known in the art as has already been described above and have been referred to in the examples.

Preferably, the concentration deamidating enzyme, the incubation time and temperature are preferably chosen such that the deamidation ratio of dairy proteins present in the composition is 70% or higher

After the deamidation step, the deamidase may be deactivated e.g. by a heating step of 5 minutes at 80° C.

In step c) the pH is adjusted to between 4.8 and 5.4 by means of the addition of an acid. Alternatively, or in combination therewith, in step a) or b) a starter culture comprising lactic acid bacteria may be added to the protein composition. In step c) of the method of the present invention said bacteria are allowed to grow until a pH between 4.8 and 5.4 is reached.

If a food grade acid is used for lowering the pH, organic acids such as malic acid, citric acid, lactic acid and/or the acidulant gluconodeltalacton (GDL) are preferred.

Preferably, in step c) the pH of the composition is adjusted to a pH between 4.8 and 5.2.

A second aspect of the present invention relates to an acid dairy drink obtainable by the method as described above.

The casein and/or caseinate in said drink will have a deamidation ratio of 50% or more and preferably of 70% or more.

Typically said dairy drink comprises deamidated casein and/or caseinate which has an iso-electrical point (IEP) which is at least 0.5 below the IEP of native casein or non-deamidated caseinate.

Hence, the iso-electric pH of the deamidated α_{S1}-casein is 4 or less, for the deamidated α_{S2}-casein it will be 4.5 or less, for β-casein it will be 4.3 or less; and for κ-casein it will be 5.1 or less. The same applies to caseinates, as they are made up from the same proteins.

In a preferred embodiment of the present invention the dairy drink comprises 2 to 5% by weight deamidated casein. Such a casein content is particularly suitable for easy to drink convenience dairy drinks.

In another preferred embodiment of the present invention the acid dairy drink comprises 5 to 20% by weight deamidated caseinate. Such a caseinate content is particularly suitable for medical nutrition.

A third aspect of the present invention relates to an acid dairy drink comprising:
at least 60% by weight water;
a pH between 4.8 and 5.4;
at least 1% by weight deamidated casein and/or deamidated caseinate, wherein the deamidated casein and/or deamidated caseinate has an iso-electrical point which is at least 0.5 below the iso-electrical point of native casein or non-deamidated caseinate, respectively.

Typically, the iso-electric pH of the deamidated α_{S1}-casein is 4 or less, for the deamidated α_{S2}-casein it will be 4.5 or less, for β-casein it will be 4.3 or less; and for κ-casein it will be 5.1 or less. The same applies to caseinates, as they are made up from the same proteins.

Contrary to known dairy drinks, the dairy drink according to the present invention has a smooth structure without aggregates, a relatively high dairy protein content, in particularly a high casein and/or caseinate content, an acidity which is in general positively perceived by consumers and an excellent stability and shelf life.

In the art, acid dairy drinks with a relatively high protein content are known, however they are made from gels which are broken down by means of stirring. Due to the breakage of the gel syneresis occurs which leads to phase separation, stability issues and a reduced shelf life. Moreover, such dairy drinks often comprise larger protein aggregates which are negatively perceived by consumers. Other examples of acid high protein drinks are composed mainly of whey proteins and/or protein hydrolysates.

As already pointed out above, the dairy drink according to the present invention is particularly suitable for persons in need of increasing the amount of proteins in their diet, such as persons recovering from an operation or for the elderly which generally suffer from a reduced daily intake of nutrients, in particular proteins.

Due to the deamidation treatment, the molar ratio of glutamine to glutamic acid has changed and consequently the iso-electric point of the casein or caseinate has also changed. Due to this change of the iso-electric point, the dairy drink according to the present invention can comprise a relatively high amount of casein or caseinate at the given pH without forming a gel.

In a preferred embodiment the dairy drink according to the present invention comprises 2 to 5% by weight deamidated casein. Such a deamidated casein content is particularly suitable for easy to drink convenience dairy drinks.

In another preferred embodiment of the present invention the acid dairy drink comprises 5 to 20% by weight deamidated caseinate. Such a deamidated caseinate content is particularly suitable for medical nutrition.

The acid dairy drink according to the present invention, preferably has a pH between 4.8 and 5.2.

The present invention will be illustrated further by means of the following non-limiting examples.

### EXAMPLES

### Example 1: Preparation of Deamidated Skim Milk

UHT treated skim milk (“Langlekker” from Friese Vlag) with 0.3% fat and 2.7 wt % casein was used for all tests described in this example. The enzyme used was a protein-deamidating enzyme (Protein Glutaminase 500) from Chryseobacterium proteolyticum sp. nov obtainable from Amano (500 U/g of powder). Wherein one unit is defined as the quantity of enzyme which will produce 1 μmol of ammonia per 1 minute as laid down in the Gras-notification of this enzyme of 14 Nov. 2008).

### Test 1:

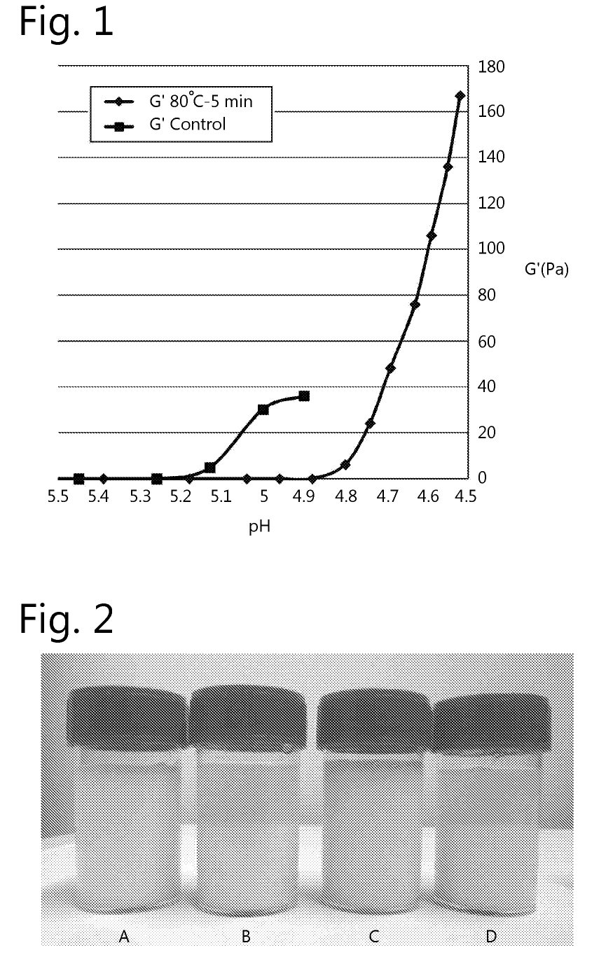

After incubation of the milk with deamidase (0.2 U/g milk) at 50° C. for 2 hours and a heat treatment at 80° C. for 5 min to inactivate the enzyme, 1.5% GDL was added and incubated at 40° C. The G′ was followed during acidification. From FIG. 1 it can easily be seen that gelling did not occur in the pH range of 4.8 to 5.4 as presently claimed, as G′ was well below 10. At a pH below 4.8 gelling occurred quickly.

As a control said skim milk was used, however the deamidation treatment as described above was not applied. From FIG. 1, it is clear that as of a pH of about 5 gelling occurred.

### Test 2:

Skim milk was incubated with deamidase (0.2 u/g milk, 150 minutes 50° C.) and the enzyme was inactivated (80° C. for 5 min). After this 1.1-1.2% GDL was added, the samples were cooled and stored at 4° C. Both non-treated samples (B and D) gelled and showed syneresis, the enzyme treated samples (A en C) stayed fluid-like as has been depicted in FIG. 2. The samples A and B comprised 1.1% by weight GDL and had a final pH of 5.0 and the samples C and D comprised 1.2% by weight GDL and had a final pH of 4.9

### Test 3:

Skim milk was incubated with deamidase (0.2 u/g milk) for 150 minutes at 50° C. and after this the enzyme was inactivated (80° C. for 5 min). The milk was cooled to 4° C., 1.1-1.4% GDL was added and samples were stored. After 72 hours the samples were judged visually on consistency. With a concentration of 1.2% GDL (w/w) and a final pH of 4.86 the sample was clearly a homogeneous liquid. All control samples (no deamidation) showed clear gelling at pH's below 5.2

TABLE 1

| % GDL | pH | Gel/Fluid |
|---|---|---|
| 1.0 | 5.0 | Fluid |
| 1.15 | 4.9 | Fluid |
| 1.20 | 4.8 | Fluid |
| 1.35 | 4.7 | Gel |
| 1.40 | 4.6 | Gel |

Hence, it is clear from Table 1 that within the claimed pH range of 4.8 to 5.4 it is possible to prepare with deamidated milk proteins an acid dairy drink.

### Example 2: Determination of the IEP Shift of Milk Proteins

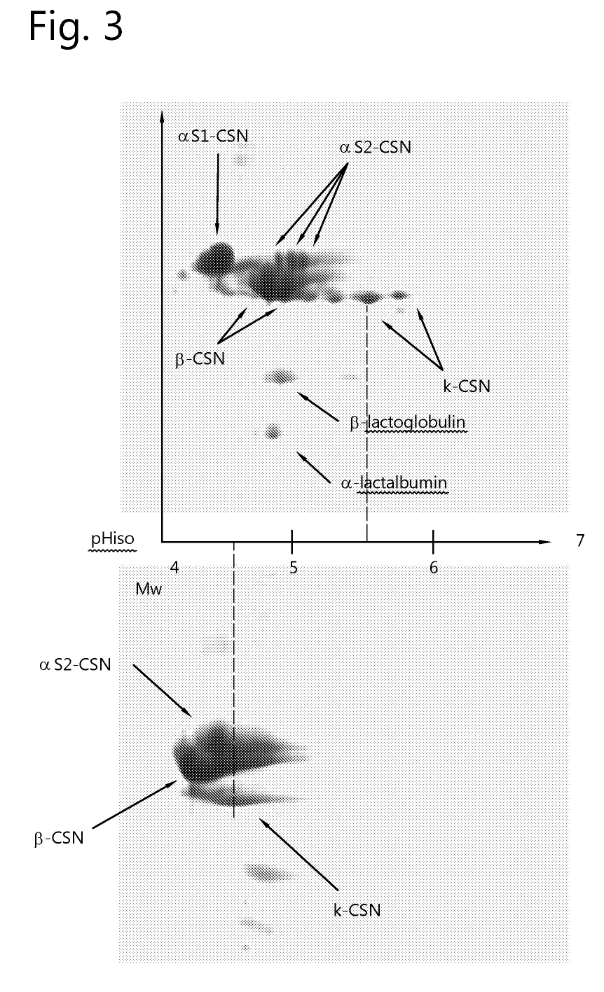

The iso-electrical point (IEP) of the different proteins in skim milk was measured using 2-dimensional electrophoresis (Pharmacia PhastSystem). UHT treated skim milk (Langlekker) with 0.3% fat was used. The enzyme was a protein-deamidating enzyme from Chryseobacterium proteolyticum sp. nov obtainable from Amano (500 U/g of powder). Incubation occurred at an enzyme concentration of 0.2 U/g of milk and 50° C. for 4 hours. The treated samples have been heated at 70° C. for 10 minutes in order to inactivate the enzyme and subsequently cooled down in ice for 10 minutes before being stored at 4° C. Control samples were also incubated at 50° C. in duplicates before being heated, cooled and stored in the same conditions that treated samples. An example of the results is shown in FIG. 3.

From this FIG. 3 it is clear that all deamidated proteins showed a clear and also complete shift in IEP. There was no recognizable amount of casein or whey protein that was not affected by this enzyme treatment. The IEP shift was for the different proteins as follows: ΔpHi (κ-csn)≈1.0; ΔpHi (β-csn)≈0.8; ΔpHi (αs2-csn)≈0.7; ΔpHi (αs1-CSN) more than 0.5. These values of IEP shift observed are in line with the IEP shifts reported in the literature (e.g. Motoki et al., 1986 in Agricultural and Biological Chemistry).

### Example 3: Preparation of a Deamidated Sodium Caseinate Composition

A 15% protein dispersion of Na-caseinate (EM 7, FrieslandCampina DMV) in 5% Consense 50 (Permeate powder, FrieslandCampina) was prepared at 60° C. and subsequently cooled to 50° C. and inoculated with protein glutaminase (PG) “Amano” 500 (500 U/g of enzyme powder; Amano Enzyme, Inc.) at a dosage of 3.5 U/g of protein (i.e. caseinate). Subsequently, the mixture was incubated at 50° C. overnight. After dilution to 6, 8, 10 and 12% protein with milk permeate, the pH was set to 5.4 with citric acid and the enzyme was inactivated by a heat treatment for 30 minutes at 90° C. A non deamidated 6% protein sample was prepared in a similar way. Samples were judged visual on viscosity and general appearance and tasted by a group of researchers.

All samples were homogeneous; some foam was visible on the sample with the highest protein content. The reference sample had a white colour; the deamidated samples were translucent. The 6% deamidated protein dispersion had a clearly lower viscosity than the not treated 6% dispersion. In addition, the reference sample was white, which shows that a considerable amount of caseinate was not dissolved and would cause stability problems upon further storage of the composition. The samples which have been subjected to deamidation were translucent, which shows that the deamidated caseinate is dissolved, which greatly contributes to the shelf life of the product.

### Example 4: Determination of the IEP Shift and Deamidation Ratio of a Sodium Caseinate Composition

A 20% sodium caseinate suspension (94.6% dry solids, 95.3% protein on dry matter; FrieslandCampina DMV, Veghel, The Netherlands) was pre-heated at 50° C. and subsequently inoculated with protein glutaminase (PG) “Amano” 500 (500 U/g of enzyme powder; Amano Enzyme, Inc.) at a dosage of 3.5 U/g of protein. Subsequently, the mixture was incubated at 50° C. During incubation samples were taken at different points in time (typically after 1, 3 and 7 h) and heated (1 minute at 90° C.) to inactivate the enzyme. To obtain powdered material, samples were freeze-dried and stored at ambient temperature until further use.

Deamidated caseinate was characterized on the degree of modification applying regular sodium caseinate as a reference.

Test 1: Effect of Incubation Time with Protein Glutaminase on the IEP of Sodium Caseinate

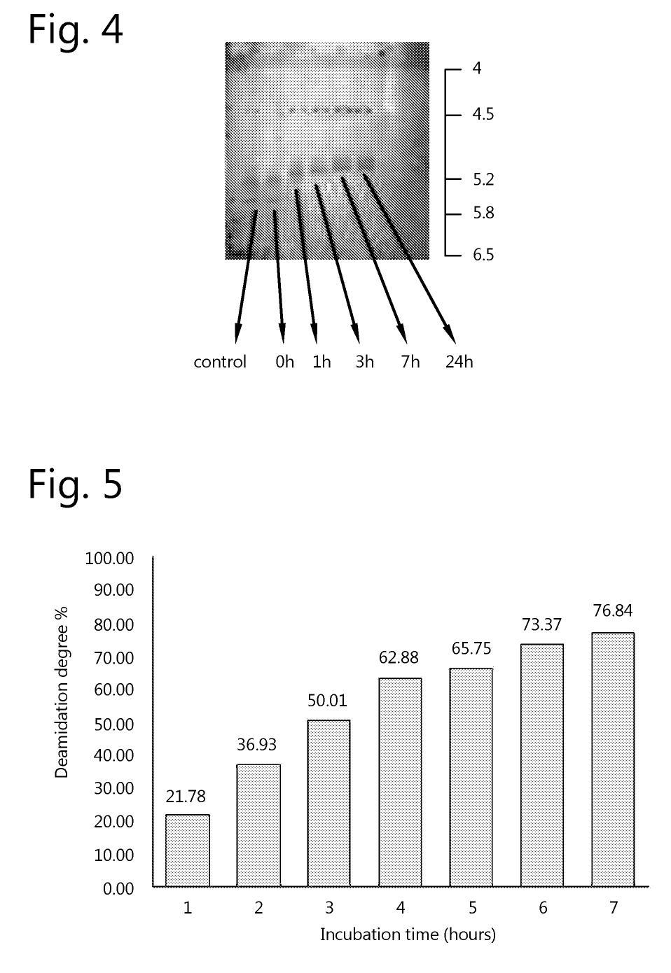

Electrophoresis was performed by using a PhastSystem (Pharmacia) electrophoresis system and precast gels (IEF4-6; 8/1 sample applicators) according to the manufacturer's instructions. Samples were applied at a final protein concentration of 1 mg/mL and stained using the Coomassie-blue staining method. From FIG. 4 it is clear that increasing incubation times lead to a considerably lower iso-electrical point (IEP) of caseinate. Hence, the presence of casein or caseinate having a lowered IEP shows that these proteins have been subjected to a deamidation treatment.

### Test 2: Deamidation Ratio of Deamidated Sodium Caseinate

The degree of deamidation was determined using an ammonia assay kit (Sigma-Aldrich, Inc.) according to the manufacturer's instructions. In order to determine the degree of deamidation of each sample, first the theoretical amount of glutamine residues in sodium caseinate was calculated. For this, an average molecular mass of caseins equal to 22.5 KDa was taken and a ratio of as1-casein: as2-casein: β-casein: k-casein equal to 4:1:4:1. The total amount of available ammonia of the glutamine residues in a 20% (wt/wt) sodium caseinate suspensions is than approximately 132.14 mmol/L. Values were expressed as a percentage of that. The results of this test are provided in FIG. 5. Hence, with this test it is possible to readily determine the deamidation ratio of the deamidated casein or caseinate as referred to in the present invention.

Both IEF and determination of the reaction product ammonia clearly showed that depending on the incubation time a range of modification degrees of deamidated caseinate could be produced.

1.-18. (canceled)

19. A method for the preparation of an acidic dairy drink comprising at least 1% by weight casein and/or caseinate, wherein the method comprises:
(a) providing an aqueous dairy protein composition having a pH between 5.5 and 8 and comprising:
(i) at least 1% by weight casein and/or caseinate;
(ii) at least 60% by weight water;
(b) adding a deamidating enzyme to the aqueous dairy protein composition and allowing the enzyme to deamidate the casein and/or caseinate present in the composition to a deamidation ratio of the deamidated casein and/or caseinate of 50% or more; and
(c) adjusting the pH of the composition to a pH between 4.8 and 5.4, such that an acid dairy drink is obtained.

20. The method according to claim 19, wherein in the deamidation ratio of the deamidated casein and/or caseinate is 70% or more.

21. The method according to claim 19, wherein the aqueous dairy composition comprises 2 to 5% by weight casein.

22. The method according to claim 19, wherein the aqueous dairy protein composition comprises milk or skimmed milk.

23. The method according to claim 19, wherein the aqueous dairy composition comprises 5 to 20% by weight caseinate.

24. The method according to claim 19, wherein the deamidating enzyme is protein-glutaminase (PG).

25. The method according to claim 19, wherein the concentration of deamidating enzymes is 0.01 to 100 units per gram of the aqueous dairy protein composition.

26. The method according to claim 25, wherein the deamidating enzymes are protein-transglutaminases.

27. The method according to claim 25, wherein the concentration of deamidating enzymes is 0.01 to 10 units per gram of the aqueous dairy protein composition.

28. The method according to claim 19, wherein the aqueous dairy protein composition is incubated for at least 1 minute at 10 to 60° C.

29. The method according to claim 19, wherein the aqueous dairy protein composition is incubated for at least 2 hours at 40° to 60° C. with 0.01 to 10 units protein-transglutaminase per gram of the aqueous dairy protein composition.

30. The method according to claim 19, wherein the aqueous dairy protein composition is incubated for such a period of time that the iso-electrical point of the deamidated casein or caseinate formed is at least 0.5 lower than native casein or non-deamidated caseinate, respectively.

31. The method according to claim 19, wherein in step (a) or (b), a starter culture comprising lactic acid bacteria is added to the protein composition, and wherein in step (c), the bacteria are allowed to adjust the pH to between 4.8 to 5.4.

32. The method according to claim 19, wherein the pH of the composition is adjusted to a pH between 4.8 and 5.2.

33. An acidic dairy drink obtainable by the method according to claim 19.

34. The acidic dairy drink according to claim 33, wherein the deamidated casein and/or caseinate has a deamidation ratio of 50% or more.

35. An acid dairy drink having a pH between 4.8 and 5.4 and comprising:
(i) at least 60% by weight water;
(ii) at least 1% by weight deamidated casein and/or deamidated caseinate, wherein the deamidated casein and/or caseinate has an iso-electrical point which is at least 0.5 below the iso-electrical point of native casein or non-deamidated caseinate, respectively.

36. The acidic dairy drink according to claim 35, comprising 2 to 5% by weight deamidated casein.

37. The acidic dairy drink according to claim 35, comprising 5 to 20% by weight deamidated caseinate.

38. The acid dairy drink according to 35, having a pH between 4.8 and 5.2.
